(19) United States
(12) Patent Application Publication
(10) Pub. No.: US 2010/0067364 A1
(43) Pub. Date: Mar. 18, 2010

(54) METHOD AND SYSTEM FOR VARIANCE-BASED AUTOMATIC GAIN CONTROL IN OFDM SYSTEMS

(76) Inventors: Francis Swarts, San Diego, CA (US); Mark Kent, Vista, CA (US)

Correspondence Address: MCANDREWS HELD & MALLOY, LTD, 500 WEST MADISON STREET, SUITE 3400, CHICAGO, IL, 60661, US

(21) Appl. No.: 12/251,090

(22) Filed: Oct. 14, 2008

Related U.S. Application Data
(60) Provisional application No. 61/096,464, filed on Sep. 12, 2008.

(51) Int. Cl. H04J 11/00

(52) U.S. Cl. 370/208

(57) ABSTRACT

Aspects of a method and system for variance-based automatic gain control in OFDM systems may include automatically controlling a gain for one or more received Orthogonal Frequency Division Multiplexing (OFDM) signals based on at least a signal variance derived from the received OFDM signals. The gain may be controlled via a variable gain amplifier, where the variable gain amplifier may be controlled via an analog and/or digital signal. The signal variance may be determined in an automatic gain control (AGC) circuit. The gain may be controlled via a feedback circuit. The signal variance may be generated via a difference between a mean-square signal and a mean-value-squared signal based on the received OFDM signals. The automatic gain control module may comprise a logarithm module, an integrator, and a dB-to-voltage mapper. The variance signal may be determined over a received slot of data.

### CROSS-REFERENCE TO RELATED APPLICATIONS/INCORPORATION BY REFERENCE

This application makes reference to, claims priority to, and claims the benefit of U.S. Provisional Application Ser. No. 61/096,464, filed on Sep. 12, 2008.

### FIELD OF THE INVENTION

Certain embodiments of the invention relate to signal processing for communication systems. More specifically, certain embodiments of the invention relate to a method and system for variance-based automatic gain control in OFDM systems.

### BACKGROUND OF THE INVENTION

Mobile communication has changed the way people communicate and mobile phones have been transformed from a luxury item to an essential part of every day life. The use of mobile phones is today dictated by social situations, rather than hampered by location or technology. While voice connections fulfill the basic need to communicate, and mobile voice connections continue to filter even further into the fabric of every day life, the mobile Internet is the next step in the mobile communication revolution. The mobile Internet is poised to become a common source of everyday information, and easy, versatile mobile access to this data will be taken for granted.

Third (3G) and fourth generation (4G) cellular networks have been specifically designed to fulfill these future demands of the mobile Internet. As these services grow in popularity and usage, factors such as cost efficient optimization of network capacity and quality of service (QoS) will become even more essential to cellular operators than it is today. These factors may be achieved with careful network planning and operation, improvements in transmission methods, and advances in receiver techniques. To this end, carriers need technologies that will allow them to increase throughput and, in turn, offer advanced QoS capabilities and speeds that rival those delivered by cable modem and/or DSL service providers. Recently, advances in multiple antenna technology and other physical layer technologies have started to significantly increase available communication data rates.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for variance-based automatic gain control in OFDM systems, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating exemplary cellular multipath communication between a base station and a mobile computing terminal, in connection with an embodiment of the invention.

FIG. 1B is a diagram illustrating an exemplary MIMO communication system, in accordance with an embodiment of the invention.

FIG. 2 is a diagram illustrating an exemplary OFDM automatic gain adjustment system, in accordance with an embodiment of the invention.

FIG. 3 is a diagram of an exemplary variance-based automatic gain control, in accordance with various embodiments of the invention.

FIG. 4 is a flow chart illustrating an exemplary automatic gain control, in accordance with an embodiment of the invention.

### DETAILED DESCRIPTION OF THE INVENTION

Certain embodiments of the invention may be found in a method and system for variance-based automatic gain control in OFDM systems. Aspects of the method and system for variance-based automatic gain control in OFDM systems may comprise automatically controlling a gain for one or more received Orthogonal Frequency Division Multiplexing (OFDM) signals based on at least a signal variance derived from the received OFDM signals. The gain may be controlled via a variable gain amplifier, where the variable gain amplifier may be controlled via an analog and/or digital signal. The signal variance may be determined in an automatic gain control (AGC) circuit. The gain may be controlled via a feedback circuit. The signal variance may be generated via a difference between a mean-square signal and a mean-value-squared signal based on the received OFDM signals. The automatic gain control module may comprise a logarithm module, an integrator, and a dB-to-voltage mapper. The variance signal may be determined over a received slot of data. The variance in an automatic gain control module may be determined based on a discrete input signal The one or more OFDM signals may conform to an EUTRA (LTE) standard.

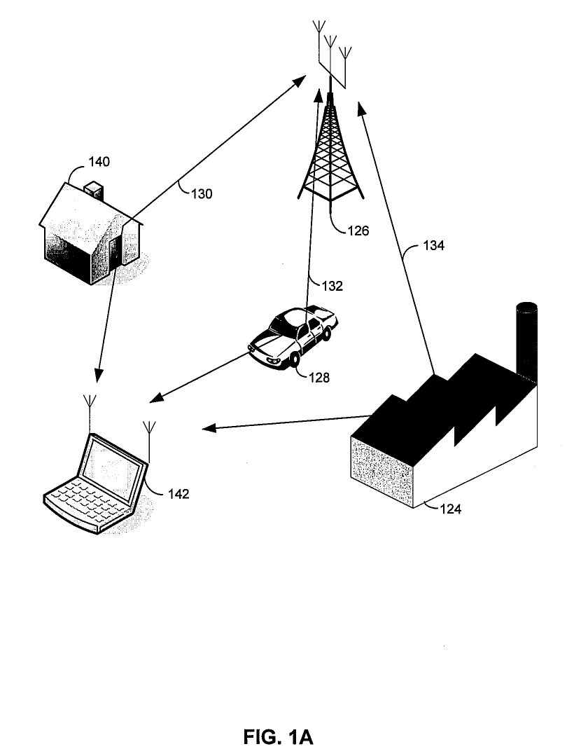

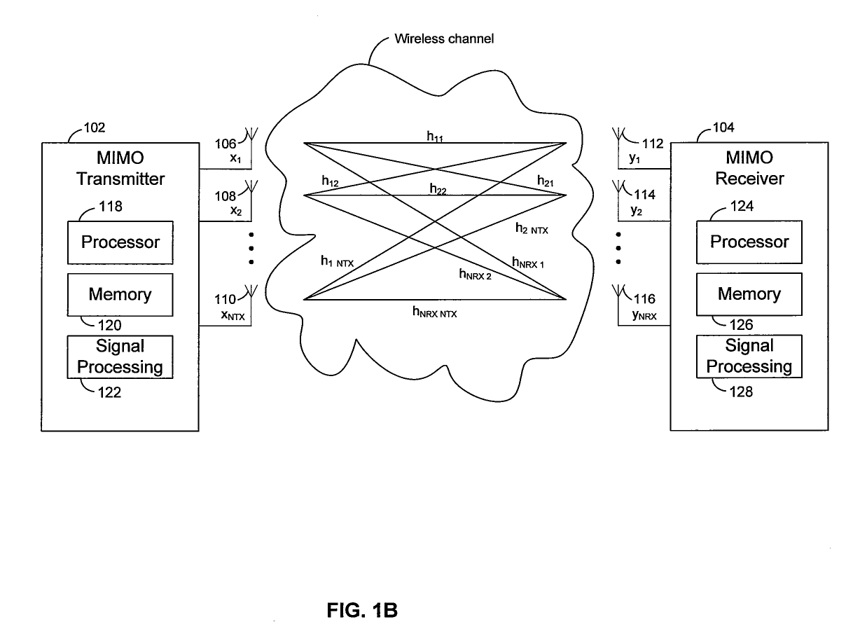

FIG. 1A is a diagram illustrating exemplary cellular multipath communication between a base station and a mobile computing terminal, in connection with an embodiment of the invention. Referring to FIG. 1A, there is shown a building 140 such as a home or office, a mobile terminal 142, a factory 124, a base station 126, a car 128, and communication paths 130, 132 and 134.

The base station 126 and the mobile terminal 142 may comprise suitable logic, circuitry and/or code that may be enabled to generate and process MIMO (Multi Input Multi Output) communication signals.

Wireless communication between the base station 126 and the mobile terminal 142 may take place over a wireless channel. The wireless channel may comprise a plurality of communication paths, for example, the communication paths 130, 132 and 134. The wireless channel may change dynamically as the mobile terminal 142 and/or the car 128 moves. In some cases, the mobile terminal 142 may be in line-of-sight (LOS) of the base station 126. In other instances, there may not be a direct line-of-sight between the mobile terminal 142 and the base station 126 and the radio signals may travel as reflected communication paths between the communicating entities, as illustrated by the exemplary communication paths 130,132 and 134. The radio signals may be reflected by man-made structures like the building 140, the factory 124 or the car 128, or by natural obstacles like hills. Such a system may be referred to as a non-line-of-sight (NLOS) communication system.

Signals communicated by the communication system may comprise both LOS and NLOS signal components. If a LOS signal component is present, it may be much stronger than NLOS signal components. In some communication systems, the NLOS signal components may create interference and reduce the receiver performance. This may be referred to as multipath interference. The communication paths 130, 132 and 134, for example, may arrive with different delays at the mobile terminal 142. The communication paths 130, 132 and 134 may also be differently attenuated. In the downlink, for example, the received signal at the mobile terminal 142 may be the sum of differently attenuated communication paths 130, 132 and/or 134 that may not be synchronized and that may dynamically change. Such a channel may be referred to as a fading multipath channel. A fading multipath channel may introduce interference but it may also introduce diversity and degrees of freedom into the wireless channel. Communication systems with multiple antennas at the base station and/or at the mobile terminal, for example MIMO systems, may be particularly suited to exploit the characteristics of wireless channels and may extract large performance gains from a fading multipath channel that may result in significantly increased performance with respect to a communication system with a single antenna at the base station 126 and at the mobile terminal 142, in particular for NLOS communication systems. Furthermore, Orthogonal Frequency Division Multiplexing (OFDM) systems may be suitable for wireless systems with multipath. In accordance with various embodiments of the invention, it may be desirable to adjust the gain of a received signal comprising the differently attenuated communication paths 130, 132, and 134, for example, to improve signal processing at the mobile terminal 142, and reduce path attenuation effects.

FIG. 1B is a diagram illustrating an exemplary MIMO communication system, in accordance with an embodiment of the invention. Referring to FIG. 1B, there is shown a MIMO transmitter 102 and a MIMO receiver 104, and antennas 106, 108, 110, 112, 114 and 116. The MIMO transmitter 102 may comprise a processor 118, a memory 120, and a signal processing module 122. The MIMO receiver 104 may comprise a processor 124, a memory 126, and a signal processing module 128. There is also shown a wireless channel comprising communication paths h₁₁, h₁₂, h₂₂, h₂₁, h_{2 NTX}, h_{1 NTX}, h_{NRX 1}, h_{NRX 2}, h_{NRX NTX}, where hₘₙ may represent a channel coefficient from transmit antenna n to receiver antenna m. There may be N_{TX} transmitter antennas and N_{RX} receiver antennas. There is also shown transmit symbols x₁, x₂ and x_{NTX}, and receive symbols y₁, y₂ and y_{NRX}.

The MIMO transmitter 102 may comprise suitable logic, circuitry and/or code that may be enabled to generate transmit symbols xᵢ iε{1,2, . . . N_{TX}} that may be transmitted by the transmit antennas, of which the antennas 106, 108 and 110 may be depicted in FIG. 1B. The processor 118 may comprise suitable logic, circuitry, and/or code that may be enabled to process signals. The memory 120 may comprise suitable logic, circuitry, and/or code that may be enabled to store and/or retrieve information for processing in the MIMO transmitter 102. The signal processing module 122 may comprise suitable logic, circuitry and/or code that may be enabled to process signals, for example in accordance with one or more MIMO transmission protocols. The MIMO receiver 104 may comprise suitable logic, circuitry and/or code that may be enabled to process the received symbols yᵢ iε{1,2, . . . N_{RX}} that may be received by the receive antennas, of which the antennas 112, 114 and 116 may be shown in FIG. 1B. The processor 124 may comprise suitable logic, circuitry, and/or code that may be enabled to process signals. The memory 126 may comprise suitable logic, circuitry, and/or code that may be enabled to store and/or retrieve information for processing in the MIMO receiver 104. The signal processing block 128 may comprise suitable logic, circuitry and/or code that may be enabled to process signals, for example in accordance with one or more MIMO protocols. An input-output relationship between the transmitted and the received signal in a MIMO system may be specified as:

y=Hx+n

where y=[y₁,y₂, . . . y_{NRX}]^{T} may be a column vector with N_{RX} elements, .^{T} may denote a vector transpose, H=[hᵢⱼ]:iε{1,2, . . . N_{RX}}; jε{1,2, . . . NTX} may be a channel matrix of dimensions N_{RX} by N_{TX}, x=[x₁,x₂, . . . x_{NTX}]^{T} is a column vector with N_{TX} elements and n is a column vector of noise samples with N_{RX} elements.

The system diagram in FIG. 1B may illustrate an exemplary multi-antenna system as it may be utilized in a Universal Mobile Telecommunication System (UMTS) Evolved Universal Terrestrial Radio Access (EUTRA) also know as Long-Term Evolution (LTE) system. The OFDM system and/or signals may conform to an Evolved Universal Terrestrial Radio Access (EUTRA) LTE standard, for example. Over each of the N_{TX} transmit antennas, a symbol stream, for example x₁(t) over antenna 106, may be transmitted. A symbol stream, for example x₁(t), may comprise one or more symbols, wherein each symbol may be modulated onto a different sub-carrier. OFDM systems may generally use a relatively large number of subcarriers in parallel, for each symbol stream. For example, a symbol stream x₁(t) may comprise symbols on carriers fₘ: mε{1,2, . . . M}, and M may be a subset of the FFT(Fast Fourier Transform) size that may be utilized at the receiver. For instance, with FFT sizes of N, N>M and may create guard-tones that may allow utilization of variable bandwidth when deployed., for example, 64, 128, or 512 sub-carriers. The M sub-carriers may comprise a symbol stream x₁(t), for example, that may occupy a bandwidth of a few kilohertz to a few megahertz. Common bandwidth may be between 1 MHz and up to 100 MHz, for example. Thus, each symbol stream may comprise one or more sub-carriers, and for each sub-carrier a wireless channel may comprise multiple transmission paths. For example, a wireless channel h₁₂ from transmit antenna 108 to receive antenna 112, as illustrated in the figure, may be multi-dimensional. In particular, the wireless channel h₁₂ may comprise a temporal impulse response, comprising one or more multipath components. The wireless channel h₁₂ may also comprise a different temporal impulse response for each sub-carrier fₘ of the symbol stream, for example x₂(t). The wireless channels as illustrated in FIG. 1B depict a spatial dimension of the wireless channel because the transmitted signal from each transmit antenna may be received differently at each receiver antenna. Thus, a channel impulse response may be measured and/or estimated for each sub-carrier. Since different communication paths, and different transmit signals may experience different attenuation, it may be desirable to dynamically adjust receiver gains. In accordance with an embodiment of the invention, a gain for one or more received Orthogonal Frequency Division Multiplexing (OFDM) signal may be automatically controlled based on a signal variance derived from the received OFDM signal. The gain may be automatically controlled via a variable gain amplifier utilizing an analog and/or digital signal

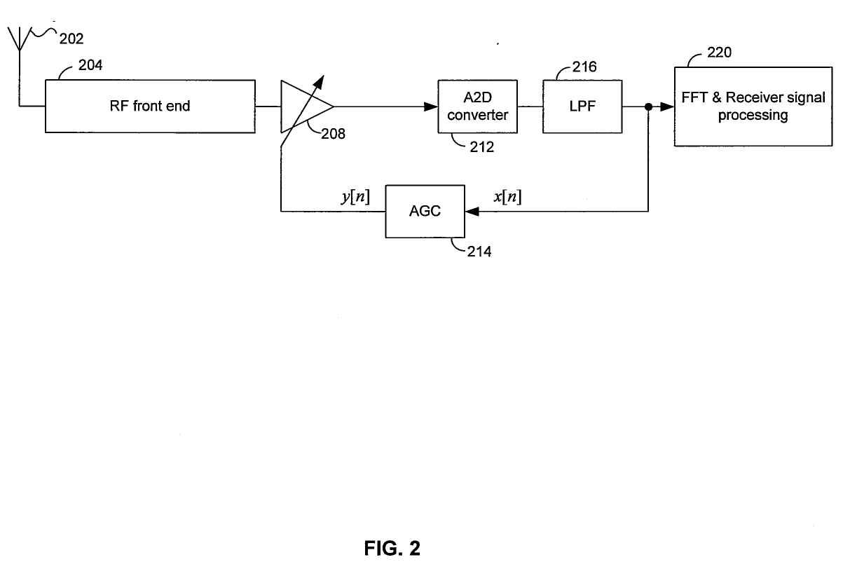

FIG. 2 is a diagram illustrating an exemplary OFDM automatic gain adjustment system, in accordance with an embodiment of the invention. Referring to FIG. 2, there is shown an antenna 202, a radio-frequency (RF) frontend 204, an amplifier 208, an analog-to-digital (A2D) converter 212, a low-pass filter 216, an automatic gain control (AGC) module 214, and an FFT and receiver signal processing module 220. There is also shown an AGC 214 input signal x[n], and an AGC 214 output signal y[n].

The antenna 202 may comprise suitable logic, circuitry and/or code that may be enabled to receive electromagnetic wave signals and convert them to electrical signals at its output. In accordance with various embodiments of the invention, the antenna 202 may comprise an antenna array, and corresponding processing units.

The RF frontend 204 may comprise suitable logic, circuitry, and or code that may be enabled to convert an RF input signal to a corresponding baseband signal. The amplifier 208 may comprise suitable logic, circuitry and/or code that may be enabled to generate an output signal that may comprise amplified and/or attenuated amplitude and/or phase of its input signal. The amplifier 208 may comprise a variable gain, which may be adjusted electronically, in accordance with an embodiment of the invention. The amplifier 208 may also be referred to as a variable gain amplifier, VGA. The gain adjustment may be achieved utilizing an analog and/or digital signal.

The A2D converter 212 may comprise suitable logic, circuitry and/or code that may be enabled to convert an analog input signal to a digital signal output signal. The LPF 216 may comprise suitable logic, circuitry and/or code that may be enabled to attenuate certain frequency components of an input signal, in its output signal. The AGC 214 may comprise suitable logic, circuitry and/or code that may be enabled to automatically adjust a gain control via its output signal, where the output signal may be a function of an input signal.

The FFT and Receiver signal processing module 220 may comprise suitable logic, circuitry and/or code that may be enabled to generate one or more FFT of a digital input signal, and process an input signal to recover transmitted information, for example. The FFT and Receiver signal processing module 220 FFT may comprise suitable logic, circuitry and/or logic that may be enabled to act as an OFDM receiver, and may furthermore comprise higher layer functionality, up to the Application layer of the open systems interconnect (OSI) model, in some instances.

In accordance with various embodiments of the invention, a signal may be received at the antenna 202. The antenna 202 may be communicatively coupled to the RF frontend 204, where the received signal may be downconverted from radio-frequency (RF) to baseband. The baseband signal may be amplified in the amplifier 208. The gain of amplifier 208 may be determined by the AGC 214. The output signal of the amplifier 208, for example, may be converted from analog to digital in the A2D 212. The LPF 216 may attenuate certain low-frequency components in the input signal, which may be introduced due to device imperfections in other devices, for example the A2D 212. The output signal of the LPF 216 may be communicatively coupled to the FFT and signal processing module 220, for further processing and/or data recovery. The output of the LPF 216 may also be fed back to the AGC 214. The AGC 214 may generate an output signal that may control the gain amplifier 208. Thus, a power control feedback loop may be formed, controlling the gain of the amplifier 208 and the signal amplitude and/or power at the output of the LPF 216.

In some instances, the AGC 214 gain control feedback circuits, may compute the signal power of the signal received at its input, x={x[n]}∀n, to drive the amplifier 208 via the output signal y={y[n]}∀n. However, the signal power P(x)=E{x²} may comprise a direct current (DC) offset, which may be introduced by imperfections in the various system components, for example component devices in the RF frontend 204, and/or the A2D converter 212. The amplifier 208 may be controlled as a function of P(x) and may, for example, increase its gain with decreasing power P(x). In some instances, the DC power component may be significant and may lead the amplifier 208 to decrease its gain below a desirable operating point. In some instances, the gain of amplifier 208 may be reduced to a level where the system may no longer function satisfactorily. Notwithstanding, the total output power at the output of the amplifier 208 (comprising the DC and non-DC components) may be adjusted to a desirable automatic gain control level. The problems associated with DC signal levels may become more significant as a DC offset level to the amplifier 208 may increase.

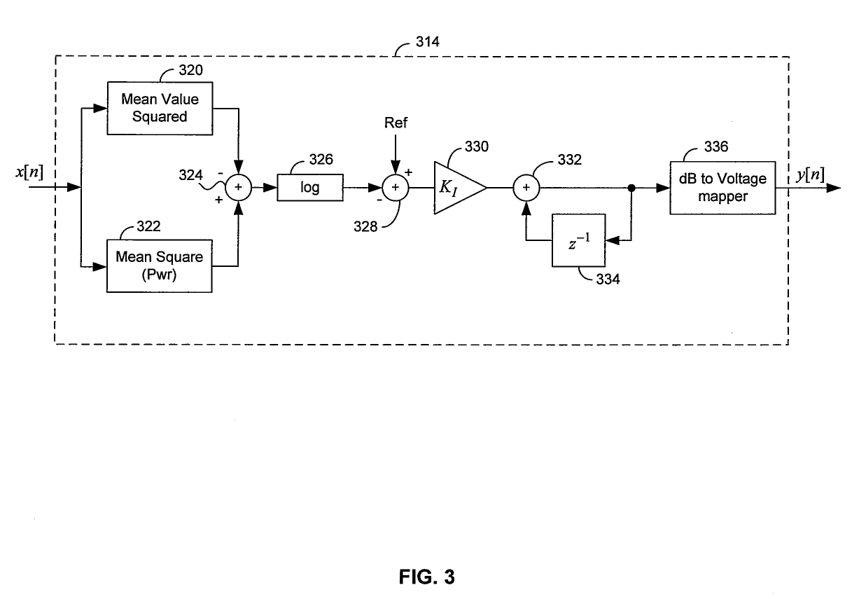

FIG. 3 is a diagram of an exemplary variance-based automatic gain control, in accordance with various embodiments of the invention. Referring to FIG. 3, there is shown an AGC 314, comprising a mean-value-squared module 320, a mean-square module 322, adders 324, 328, and 332, a logarithm module 326, an amplifier 330, a delay module 334, and a dB-to-voltage mapper 336. There is also shown an input signal x[n], and an output signal y[n].

The AGC 314 may be substantially similar to the AGC 214. The mean-value-squared module 320 may comprise suitable logic, circuitry, and/or code that may be enabled to approximately compute a mean value squared from an input signal. The mean-square module 322 may comprise suitable logic, circuitry, and/or code that may be enabled to approximately compute a mean value of a squared input signal. The adders 324, 328, and 332 may comprise suitable logic, circuitry, and/or code that may be enabled to form a weighted sum of a plurality of input signals. The logarithm module 326 may comprise suitable logic, circuitry, and/or code that may be enabled to generate an output signal that may be a logarithmic function of a received input signal. The amplifier 330 may comprise suitable logic, circuitry, and/or code that may be enabled to amplify an input signal by a factor K_{I}, for example. The delay module 334 may comprise suitable logic, circuitry, and/or code that may be enabled to delay an input signal by one or more discrete symbol periods, and/or sampling periods. The dB-to-voltage mapper 336 may comprise suitable logic, circuitry, and/or code that may be enabled to convert an input control signal to a desirable control voltage level.

As described with respect to FIG. 2, a DC power component in the input signal x[n] may be undesirable, and may lead to an unfavorable setting of gain in the amplifier 208, for example. In accordance with various embodiments of the invention, the AGC 314 may compute the input signal variance to control the amplifier 208, for example, instead of P(x). The variance for a signal x[n] may be given by the following relationship:

σₓ²=E{x²}−(E{x})²

Thus, the mean-square module 322 may determine E{x²} from the input signal x[n], and the mean-value-squared module 320 may determine (E{x})² from the input signal x[n]. The adder 324 may combine the outputs of the mean-value-squared module 320 and the mean-square module 322 to generate the variance σₓ² at its output. Since E{x} may be similar to the DC signal component in x[n], the variance may provide a measure related to the total signal power (E{x²}) minus the DC signal power component ((E{x})²). Thus, by using the signal variance σₓ², the AGC 314 control may be decoupled from the DC signal power.

In accordance with various embodiments of the invention, the variance σₓ² signal at the output of the adder 324, may be used in various control circuits that may adjust the amplifier 208, for example. For example, the variance signal may be communicatively coupled to a logarithm module 326, which may induce a logarithmic response to linear changes in the variance signal. The output of the logarithm module 326 may be communicatively coupled to the adder 328, where the difference between the generated signal and a reference signal may be generated. This difference signal generated at the output of the adder 328 may be amplified by a factor K_{I} in the amplifier 330. In accordance with an embodiment of the invention, the amplifier 330 output may be added to the previously generated input to the dB-to-voltage mapper 336 through the feedback circuit formed by the delay module 334. This feedback action may generate an integrator over a plurality of samples/symbol periods. The output of the adder 332 may be communicatively coupled to the dB-to-voltage mapper 336 that may generate the output y[n], which may be used to adjust a variable gain amplifier, for example the amplifier 208.

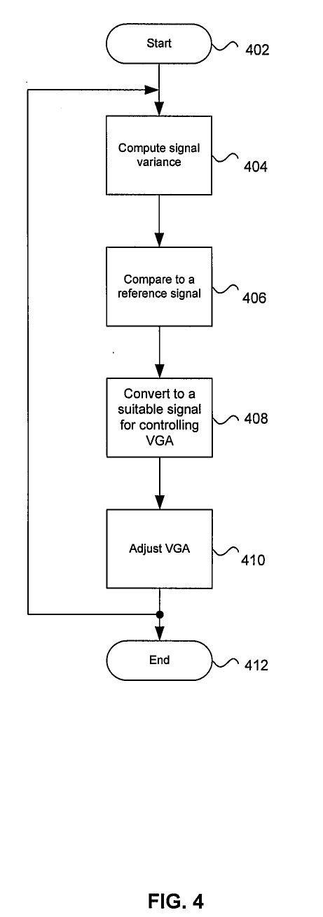

FIG. 4 is a flow chart illustrating an exemplary automatic gain control, in accordance with an embodiment of the invention. In step 404, a variance of an input signal x[n] to an AGC 214 may be computed, for example as described with regard to FIG. 3. In some instances, a difference signal between the variance signal and a reference signal may be generated, in step 406. For example through integration, and mapping, for example as described with respect to FIG. 3, a control signal y[n] may be generated in step 408. In step 410, a variable gain amplifier, for example amplifier 208, may be adjusted as a function of the variance of signal x[n]. The signal variance of x[n] may be determined in the AGC 214, based on a discrete signal x[n], for instance. The signal variance may be determined approximately over a received slot of data, for example.

In accordance with an embodiment of the invention, a method and system for variance-based automatic gain control in OFDM systems may comprise automatically controlling a gain for one or more received Orthogonal Frequency Division Multiplexing (OFDM) signals, for example via amplifier 208, based on at least a signal variance derived from the received OFDM signals, as described with respect to, for example, FIG. 2 and FIG. 3. The gain may be controlled via a variable gain amplifier 208, where the variable gain amplifier 208 may be controlled via an analog and/or digital signal, communicatively coupled from the output of the automatic gain control module 214. The signal variance may be determined in an automatic gain control (AGC) circuit 214 or 314, for example. The gain may be controlled via a feedback circuit, as illustrated in, for example, FIG. 2 and FIG. 3. The signal variance may be generated in adder 324 via a difference between a mean-square signal from module 322 and a mean-value-squared signal from module 320 based on the received OFDM signals. The automatic gain control module 314 and/or 214 may comprise a logarithm module 326, an integrator comprising adder 332 and delay module 334, and a dB-to-voltage mapper 336. The variance signal may be determined over a received slot of data, for example. The variance in an automatic gain control module may be determined based on a discrete input signal, as described with regard to FIG. 2, FIG. 3 and FIG. 4. The one or more OFDM signals may conform to a EUTRA (LTE) standard in some instances, as described with regard to FIG. 1B, for example.

Another embodiment of the invention may provide a machine-readable and/or computer-readable storage and/or medium, having stored thereon, a machine code and/or a computer program having at least one code section executable by a machine and/or a computer, thereby causing the machine and/or computer to perform the steps as described herein for variance-based automatic gain control in OFDM systems.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing communication signals, the method comprising:
automatically controlling a gain for one or more received Orthogonal Frequency Division Multiplexing (OFDM) signals based on at least a signal variance derived from said received OFDM signals.

2. The method according to claim 1, comprising controlling said gain via a variable gain amplifier.

3. The method according to claim 2, comprising adjusting said gain of said variable gain amplifier via an analog and/or digital signal.

4. The method according to claim 1, comprising determining said signal variance in an automatic gain control (AGC) circuit.

5. The method according to claim 1, comprising controlling said gain via a feedback circuit.

6. The method according to claim 1, comprising generating said signal variance via a difference between a mean-square signal and a mean-value-squared signal based on said received OFDM signals.

7. The method according to claim 1, wherein said automatic gain control module comprises a logarithm module, an integrator, and a dB-to-voltage mapper.

8. The method according to claim 1, wherein said variance signal is determined over a received slot of data.

9. The method according to claim 1, comprising determining said variance in an automatic gain control module based on a discrete input signal.

10. The method according to claim 1, wherein said one or more OFDM signals conform to a EUTRA (LTE) standard.

11. A system for processing communication signals, the system comprising:
one or more circuits operable to:
automatically control a gain for one or more received Orthogonal Frequency Division Multiplexing (OFDM) signal based on a signal variance derived from said one or more received OFDM signal.

12. The system according to claim 11, wherein said one or more circuits control said gain via a variable gain amplifier.

13. The system according to claim 12, wherein said one or more circuits adjust said gain of said variable gain amplifier via an analog and/or digital signal.

14. The system according to claim 11, wherein said one or more circuits determine said signal variance in an automatic gain control (AGC) circuit.

15. The system according to claim 11, wherein said one or more circuits control said gain via a feedback circuit.

16. The system according to claim 11, wherein said one or more circuits generate said signal variance via a difference between a mean-square signal and a mean-value-squared signal based on said received OFDM signals.

17. The system according to claim 11, wherein said automatic gain control module comprises a logarithm module, an integrator, and a dB-to-voltage mapper.

18. The system according to claim 11, wherein said variance signal is determined over a received slot of data.

19. The system according to claim 11, wherein said one or more circuits determine said variance in an automatic gain control module based on a discrete input signal.

20. The system according to claim 11, wherein said one or more OFDM signals conform to a EUTRA (LTE) standard.
